(19) United States
(12) Patent Application Publication
(10) Pub. No.: US 2020/0408152 A1
(43) Pub. Date: Dec. 31, 2020

(54) GEARBOX AND GAS TURBINE PROPULSION UNIT

(71) Applicant: Rolls-Royce Deutschland Ltd & Co KG, Blankenfelde-Mahlow (DE)

(72) Inventors: Gregor KAPPMEYER, Bad Homburg (DE); Gideon Daniel VENTER, Berlin (DE); Jan SCHWARZE, Berlin (DE); Daniel SIEGHART, Rangsdorf (DE)

(21) Appl. No.: 16/908,398

(22) Filed: Jun. 22, 2020

(30) Foreign Application Priority Data
Jun. 25, 2019 (DE) 10 2019 117 038.9

(51) Int. Cl. F02C 7/36; F16H 1/28; F16H 57/08

(52) U.S. Cl. CPC F02C 7/36; F16H 1/28; F05D 2260/40311; F16H 2057/085; F05D 2220/32; F16H 57/082

(57) ABSTRACT

A gear box, in particular a planetary gear box of a gas turbine engine, is proposed, having at least one planet carrier which comprises two webs which are spaced apart in an axial direction. By means of the webs, at least one planet gear which is configured to be rotatable relative to the planet carrier is operatively connected to the planet carrier. An axis of rotation of the planet gear, below or in the case of a defined load-dependent deformation of the planet carrier, deviates from a parallel course of an axis of symmetry of the planet carrier. Furthermore, the axis of rotation of the planet gear, in the case of a further defined load-dependent deformation of the planet carrier greater than the defined load-dependent deformation of the planet carrier, runs at least approximately parallel to the axis of symmetry of the planet carrier.

This application claims priority to German Patent Application DE102019117038.9 filed Jun. 25, 2019, the entirety of which is incorporated by reference herein.

The present disclosure relates to a gear box, in particular a planetary gear box of a gas turbine engine, having at least one planet carrier which comprises at two webs which are spaced apart from one another in an axial direction. The present disclosure furthermore relates to a gas turbine engine for an aircraft.

Simple planetary gear boxes known from practice commonly comprise a sun gear, a ring gear and a planet carrier on which at least one planet gear is rotatably mounted. The planet gear is in engagement both with the ring gear and with the sun gear. For the coupling to rotatable or rotationally fixed regions of a gas turbine engine, the shafts of the planetary gear box, or the sun gear, the ring gear and the planet carrier, are configured with connecting regions.

Here, provision may be made whereby the planet carrier comprises two webs which are spaced apart from one another in an axial direction. In the region of the webs, the planet gears, which are in each case configured to be rotatable relative to the planet carrier, are operatively connected to the planet carrier.

During the operation of a gas turbine engine, the torques acting on a planetary gear box of said type can cause twisting or distortion of the sun gear, of the ring gear, of the planet gear and of the planet carrier in a circumferential direction or in a tangential direction, and of the planet carrier also in a radial direction. Here, the tangential deformations in the region of the planet carrier or between the webs of a planet carrier arise in particular if connecting regions of the planet carrier extend in an axial direction of the planetary gear box between the planet carrier of the planetary gear box and the rotatable or the rotationally fixed regions of a gas turbine engine. The distortion or twisting increases also in an axial direction of the planetary gear box, in each case in particular between a connecting region of a web of the planet carrier and the respectively oppositely situated web of the planet carrier, with a respectively defined course in a manner dependent on the respectively present component stiffness of the planet carrier.

Furthermore, the twisting or inclination of the various components of a planetary gear box in turn have the effect that an orientation of tooth flanks of the tooth regions, which are in engagement with one another, of the planet gears with at least one sun gear and/or with at least one ring gear is rotated or pivoted, proceeding from an unloaded operating state of the planetary gear box in the direction of an operating range of a gas turbine engine in which high loads act on the planetary gear box, owing to the load that acts during operation. This has the effect that contact areas between teeth, which are in engagement with one another, of the abovementioned toothing regions are reduced to an undesired extent during operation.

Here, it is possible for inadmissibly high contact pressures or loads to arise in the region of the contact areas of the toothing regions, which permanently impair the functioning of the planetary gear box owing to irreversible damage to the tooth flanks. In order to limit the twisting or distortion in the region of a sun gear, of a ring gear, of a planet gear and in particular in the region of a planet carrier to a desired extent, these must be designed with correspondingly high component stiffness. This approach however entails large component dimensions, resulting in a high component weight of a planetary gear box, which however opposes the design criteria of gas turbine engines or aircraft engines.

It is furthermore also possible to provide a profile correction by means of the respective tooth width in the region of the points of tooth engagement, wherein, for this purpose, it is in turn necessary for the tooth flanks to be designed to be correspondingly larger and wider. This however also increases the component dimensions of a planetary gear box and thus disadvantageously, in turn, the component weight of a planetary gear box.

It is the intention to provide a gear box which is favourable in terms of structural space and which is characterized by a low component weight and which is furthermore characterized by a long service life. It is furthermore the intention to create a gas turbine engine having a gear box of said type.

This object is achieved by means of a gear box and by means of a gas turbine engine having the features of patent claims 1 and 13 respectively.

According to a first aspect, a gear box, in particular a planetary gear box of a gas turbine engine, having at least one planet carrier is provided. The planet carrier comprises two webs which are spaced apart from one another in an axial direction. In the region of the webs, at least one planet gear which is configured to be rotatable relative to the planet carrier is operatively connected to the planet carrier. The planet gear is in engagement with at least one ring gear and/or with at least one sun gear. Furthermore, an axis of rotation of the planet gear, below or in the case of a defined load-dependent deformation of the planet carrier, deviates from a course parallel to an axis of symmetry of the planet carrier. It is additionally provided that the axis of rotation of the planet carrier, in the case of a further defined load-dependent deformation of the planet carrier greater than the defined load-dependent deformation of the planet carrier, runs at least approximately parallel to the axis of symmetry of the planet carrier.

Here, in the present case, a load-dependent deformation of the planet carrier is to be understood to mean a deformation of the planet carrier in particular between the two webs thereof, in the case of which, during the operation of the gear box, one web is rotated relative to the other web in a tangential direction or in a circumferential direction of the planet carrier. Additionally, a defined load-dependent deformation of the planet carrier is also to be understood to mean a deformation of the webs in a radial direction of the planet carrier, which is caused during operation by the centrifugal force acting in each case on the planet gears. This is the case in particular if the planet carrier itself is designed to be rotatable, wherein the axis of symmetry of the planet carrier is then identical to the axis of rotation of the planet carrier.

The axial offset that is present in particular in the load-free state of the gear box between the axis of rotation of the planet gear and the axis of symmetry of the planet carrier makes it possible in a simple manner in terms of construction for deformations that arise during the operation of the gear box, that is to say tangential twisting between the webs of the planet carrier and also radial deflections of the planet gear at defined operating points or in defined operating ranges of a gas turbine engine, to be minimized. Thus, the disadvantages known from the prior art, such as damage in the toothing region of intermeshing toothed gears of the gear box, that is to say of a sun gear, of a planet gear and of a ring gear, are avoided. This in turn makes it possible for the individual components of the gear box according to the present disclosure to be configured with small component dimensions and with a low component weight, whereby, in turn, component loads in particular in the region of bearing arrangements of the gear box are reduced in relation to known gear boxes.

Furthermore, it may be provided that the offset provided in terms of construction in particular during load-free operation of the gear box, or the deviation from parallelism between the axis of rotation of the planet gear and the axis of symmetry of the planet carrier, is configured in a manner dependent on the respectively present usage situation for defined load situations of a gas turbine engine. Such a load situation may correspond to an operating point or an operating range in which a gas turbine engine is in so-called part-load operation and in which the gas turbine engine remains over relatively long periods of operation. As an alternative to this, it is also possible for the axis offset to be provided such that the axis of rotation of the planet gear and the axis of symmetry of the planet carrier are oriented parallel to one another, and the axis offset is then minimal, for example at an operating point which is characterized by very high load. In the presence of a minimal axis offset, good engagement conditions are realized in the region of the toothings of the planet gear with the sun gear and/or with the ring gear, such that component loads of the planet gear, of the sun gear and/or of the ring gear are low.

Advantageously, the misalignment generated between the toothings of the planet gear, of the sun gear and/or of the ring gear with respect to one another by the axis offset present in the load-free operating state of the gear box is nevertheless minor, even if the gear box does not exhibit the further defined load-dependent deformation of the planet carrier.

In further construction embodiments of the gear box according to the present disclosure, it is provided that in each case one outer bearing part of a bearing of the planet gear, by means of which the planet gear is configured to be rotatable relative to the planet carrier, or in each case one end region of a planet journal on which the planet gear is rotatably mounted preferably via a sliding bearing, is arranged rotationally fixedly in a recess of a web.

If the recesses of the webs are formed as bores, the gear box according to the present disclosure can be produced with little outlay in terms of manufacturing.

Lines of symmetry of the bores may run parallel to one another and offset relative to one another in a radial and/or in a tangential direction of the webs. It is additionally possible for the lines of symmetry of the bores to be arranged parallel to the line of symmetry of the planet carrier or to enclose an acute angle with the line of symmetry of the planet carrier in order to provide the desired axis offset between the axis of rotation of the planet gear and the line of symmetry of the planet carrier.

Furthermore, it may also be provided that the lines of symmetry of the bores are at least approximately in alignment with one another and enclose an acute angle with the line of symmetry of the planet carrier in order to set the desired axis offset between the axis of rotation of the planet gear and the line of symmetry of the planet carrier.

In the bores of the webs, there may be arranged sleeves which are configured, in relation to an outer side of the sleeves, with in each case one asymmetrical bore. Here, provision may be made whereby the lines of symmetry of the asymmetrical bores of the sleeves run parallel to one another and so as to be offset relative to one another in a radial and/or in a tangential direction of the webs. It is furthermore possible for the lines of symmetry of the bores to be arranged parallel to the line of symmetry of the planet carrier and to enclose an acute angle with the line of symmetry of the planet carrier. These embodiments in turn permit easy implementation of the desired axis offset between the axis of rotation of the planet gear and the line of symmetry or the axis of rotation of the planet carrier.

For this purpose, it may also be provided that in the bores there are arranged sleeves which are configured, in relation to an outer side of the sleeves, with in each case one asymmetrical bore. Lines of symmetry of the asymmetrical bores may be at least approximately in alignment with one another and may enclose an acute angle with the line of symmetry of the planet carrier in order to provide the desired axis offset between the line of symmetry of the planet carrier and the axis of rotation of the planet gear.

In further embodiments of the gear box according to the present disclosure, lines of symmetry of outer sides of the planet journal which are operatively connected to inner sides of the bores of the webs or with inner sides of the sleeves run parallel to one another. Additionally, the lines of symmetry of the outer sides of the planet journal may run so as to be offset relative to one another in a radial and/or in a tangential direction of the webs and may either be arranged parallel to the line of symmetry of the planet carrier or enclose an acute angle with the line of symmetry of the planet carrier. It is thus in turn possible for an axis offset between the axis of rotation of the planet gear and the line of symmetry of the planet carrier to be realized or implemented in a simple manner in terms of construction.

If the unloaded planet carrier is subjected by the installed planet gear to a twist in an axial direction, which twist is directed oppositely to a twist of the planet carrier which arises during operation, the desired axis offset between the axis of rotation of the planet gear and a line of symmetry of the planet carrier can in turn be produced in a simple manner.

It may additionally also be provided that the planet carrier is subjected to a torsional moment during the installation of the planet gear, such that the axis offset between the axis of rotation of the planet gear and the axis of symmetry of the planet carrier during the installation process is small, and installation of the planet gear can be implemented with low joining forces.

A torque applied to the planet carrier can be supported, via one of the webs, in the region of a shaft which is connectable thereto, preferably of a shaft of a gas turbine engine.

In further embodiments of the gear box according to the present disclosure, the radial offset between the lines of symmetry of the bores of the webs, of the sleeves and/or of the outer sides of the planet journal is defined in a manner dependent on a radial stiffness of the planet carrier, of the planet gear and/or of the bearing of the planet gear and on a centrifugal force which acts during operation.

In addition or as an alternative to this, it may be provided that the tangential offset between the lines of symmetry of the bores of the webs, of the sleeves and/or of the outer sides of the planet journal is defined in a manner dependent on a tangential stiffness of the planet carrier, of the planet gear and/or of the bearing of the planet gear and on an engagement force which acts in the region of the toothing of the planet gear during operation.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure can be particularly, although not exclusively, beneficial for fans that are driven via a gear box. Accordingly, the gas turbine engine may comprise a gear box that receives an input from the core shaft and outputs drive for the fan so as to drive the fan at a lower rotational speed than the core shaft. The input to the gear box may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed). The gear box herein can be embodied as a gear box as has been described in more detail above.

The gas turbine engine as described and claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, second compressor and the second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The gear box may be arranged so as to be driven by that core shaft (for example the first core shaft in the example above) which is configured to rotate (for example during use) at the lowest rotational speed. For example, the gear box may be arranged so as to be driven only by that core shaft (for example only by the first core shaft, and not the second core shaft, in the example above) which is configured to rotate (for example during use) at the lowest rotational speed. Alternatively thereto, the gear box may be arranged so as to be driven by one or a plurality of shafts, for example the first and/or the second shaft in the example above.

In the case of a gas turbine engine which is described and claimed herein, a combustion chamber may be provided so as to be axially downstream of the fan and the compressor(s). For example, the combustion chamber can lie directly downstream of the second compressor (for example at the exit of the latter), if a second compressor is provided. By way of further example, the flow at the exit of the compressor may be supplied to the inlet of the second turbine, if a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator vanes, the latter potentially being variable stator vanes (in that the angle of incidence of said stator vanes can be variable). The row of rotor blades and the row of stator vanes may be axially offset from one another.

The or each turbine (for example the first turbine and the second turbine as described above) may comprise any number of stages, for example multiple stages. Each stage may comprise a row of rotor blades and a row of stator vanes. The row of rotor blades and the row of stator vanes may be axially offset from one another.

Each fan blade may be defined as having a radial span width extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which can simply be double the radius of the fan) may be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular speed). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure can have any desired bypass ratio, where the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and claimed herein may be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruising speed may be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of a gas turbine engine may be defined as the net thrust of the gas turbine engine divided by the total mass flow through the engine. The specific thrust of an engine as described and/or claimed herein at cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such gas turbine engines can be particularly efficient in comparison with conventional gas turbine engines.

A gas turbine engine as described and claimed herein may have any desired maximum thrust. Purely by way of a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

During use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide blade. At cruising speed, the TET may be at least (or of the order of): 1400 K, 1450 K, 1500 K, 1550 K, 1600 K, or 1650 K. The TET at constant speed may be in an inclusive range delimited by two of the values in the previous sentence (that is to say that the values may form upper or lower limits). The maximum TET in the use of the engine may be at least (or of the order of), for example: 1700 K, 1750 K, 1800 K, 1850 K, 1900 K, 1950 K, or 2000 K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described herein may comprise a central portion from which the fan blades can extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of further example, the fan blades can be formed integrally with a central portion. Such an arrangement may be referred to as a blisk or a bling. Any suitable method may be used to manufacture such a blisk or such a bling. For example, at least a part of the fan blades can be machined from a block and/or at least a part of the fan blades can be attached to the hub/disk by welding, such as linear friction welding, for example.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-flight, for example the conditions experienced by the aircraft and/or the gas turbine engine between end of climb and start of descent (in terms of time and/or distance).

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the magnitude of Mach 0.8, in the magnitude of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine as described and claimed herein can operate at the cruise conditions defined elsewhere herein. Such cruise conditions can be determined by the cruise conditions (for example the mid-flight conditions) of an aircraft to which at least one (for example 2 or 4) gas turbine engine can be fastened in order to provide the thrust force.

It is self-evident to a person skilled in the art that a feature or parameter described above in relation to one of the above aspects can be applied to any other aspect, unless these are mutually exclusive. Furthermore, any feature or any parameter described here may be applied to any aspect and/or combined with any other feature or parameter described here, unless these are mutually exclusive.

Embodiments will now be described, by way of example, with reference to the figures.

In the figures:

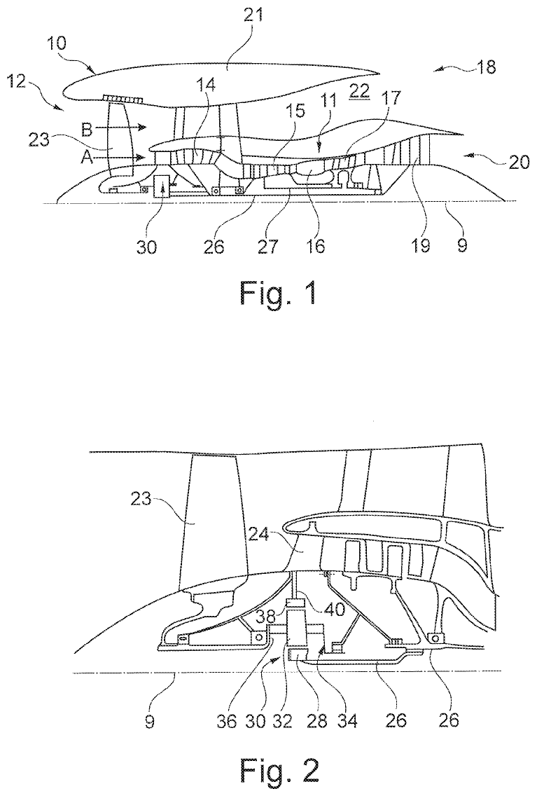

FIG. 1 shows a longitudinal sectional view of a gas turbine engine;

FIG. 2 shows an enlarged partial longitudinal sectional view of an upstream portion of a gas turbine engine;

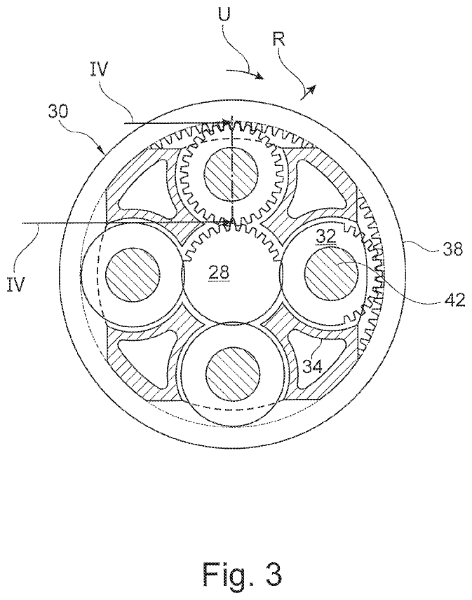

FIG. 3 shows an isolated illustration of a gear box for a gas turbine engine;

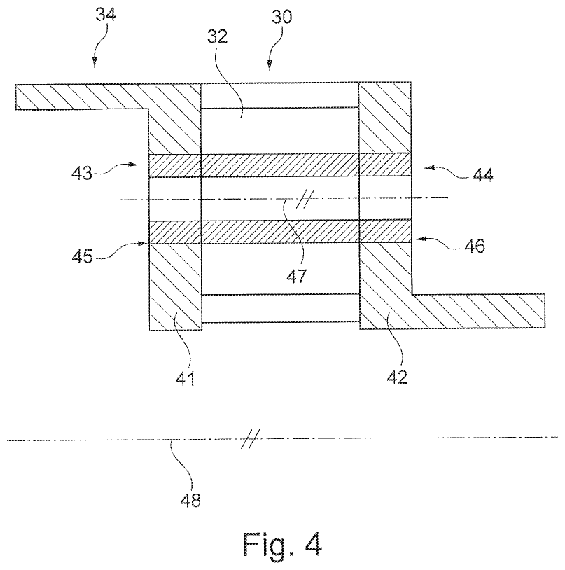

FIG. 4 shows a highly schematic partial sectional view of a planet carrier with two webs and with a planet gear operatively connected to the planet carrier, wherein an axis of rotation of the planet gear runs parallel to an axis of rotation of the planet carrier;

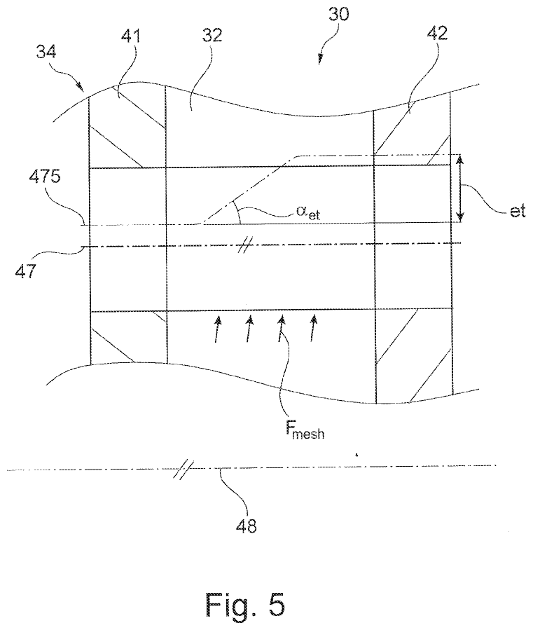

FIG. 5 shows a further schematic partial view of the planet carrier and of the planet gear as per FIG. 4 during the operation of a gas turbine engine configured with the gear box as per FIG. 2 and FIG. 3;

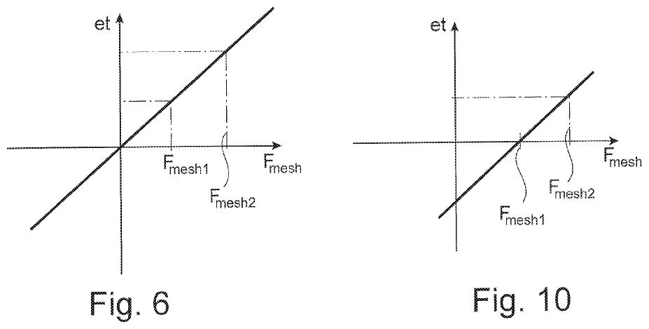

FIG. 6 shows a course of a tangential deflection of the axis of rotation of the planet gear relative to the axis of rotation of the planet carrier versus engagement forces in the region of the toothed engagement between the planet gear and a sun gear meshing therewith and/or a ring gear meshing therewith of the planetary gear box as per FIG. 4;

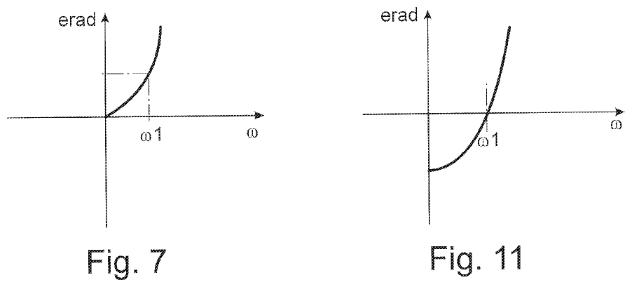

FIG. 7 shows an illustration, corresponding to FIG. 6, of a course of a radial deflection of the axis of rotation of the planet gear relative to the axis of rotation of the planet carrier as per FIG. 4 versus the rotational angular speed of the planet carrier;

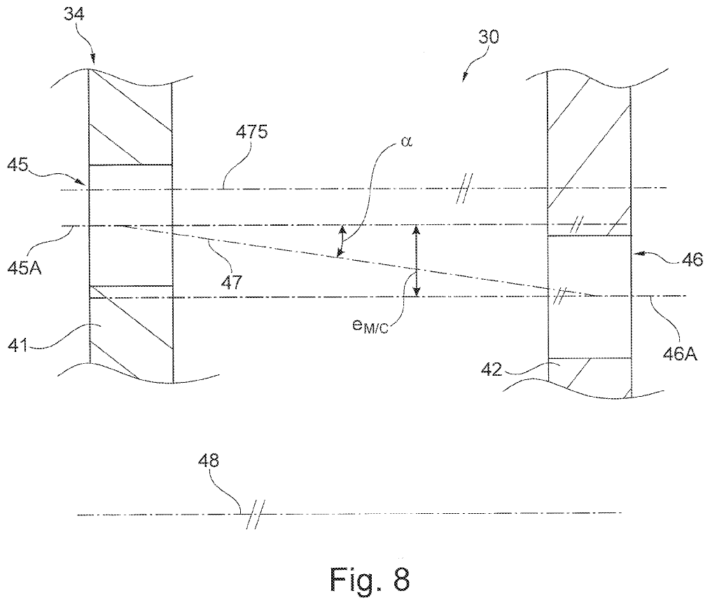

FIG. 8 shows an illustration corresponding to FIG. 5, wherein lines of symmetry of bores of the webs are oriented parallel to one another and are spaced apart from one another in a tangential direction and/or in a radial direction and are arranged parallel to the axis of rotation of the planet carrier;

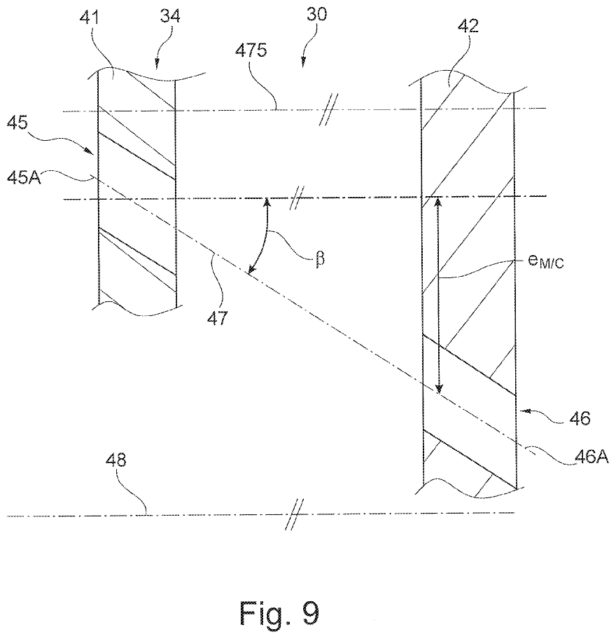

FIG. 9 shows an illustration, corresponding to FIG. 8, of a further embodiment of the gear box, in which lines of symmetry of bores of the webs of the planet carrier are in alignment with one another and enclose an angle with the axis of rotation of the planet carrier;

FIG. 10 shows an illustration, corresponding to FIG. 6, of the course of the deflection of the axis of rotation of the planet gear relative to the axis of rotation of the planet carrier versus the engagement force, which arises as a result of the axis offset, illustrated in FIG. 8 or in FIG. 9, between the axis of rotation of the planet gear and the axis of rotation of the planet carrier;

FIG. 11 shows an illustration, corresponding to FIG. 7, of the course of the deflection of the axis of rotation of the planet gear relative to the axis of rotation of the planet carrier, which arises, in relation to the course as per FIG. 7, for example as a result of the axis offset, illustrated in FIG. 8 or in FIG. 9, between the axis of rotation of the planet gear and the axis of rotation of the planet carrier.

FIG. 1 illustrates a gas turbine engine 10 with a main axis of rotation 9. The engine 10 comprises an air intake 12 and a thrust fan 23 that generates two airflows: a core airflow A and a bypass airflow B. The gas turbine engine 10 comprises a core 11 that receives the core airflow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low pressure turbine 19 by way of a shaft 26 and an epicyclic gear box 30. The shaft 26 herein is also referred to as the core shaft.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before they are expelled through the nozzle 20 to provide a certain thrust. The high-pressure turbine 17 drives the high-pressure compressor 15 by way of a suitable connecting shaft 27, which is also referred to as the core shaft. The fan 23 generally provides the majority of the propulsion force. The epicyclic gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gear box arrangement 30. Multiple planet gears 32, which are coupled to one another by means of a planet carrier 34, are situated radially outside the sun gear 28 and mesh with the latter, and are in each case arranged so as to be rotatable on carrier elements 29 which are connected in a rotationally fixed manner to the planet carrier 34. The planet carrier 34 limits the planet gears 32 to orbiting around the sun gear 28 in a synchronous manner while enabling each planet gear 32 to rotate about its own axis on the carrier elements 29. The planet carrier 34 is coupled by way of linkages 36 to the fan 23 so as to drive the rotation of the latter about the engine axis 9. Radially to the outside of the planet gears 32 and meshing therewith is an external gear or ring gear 38 that is coupled, via linkages 40, to a stationary supporting structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic gear box 30 is shown in greater detail by way of example in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic gear box 30 generally comprise at least three planet gears 32.

The epicyclic gear box 30 illustrated by way of example in FIGS. 2 and 3 is of the planetary type, in which the planet carrier 34 is coupled to an output shaft via linkages 36, wherein the ring gear 38 is fixed. However, any other suitable type of epicyclic gear box 30 can be used. By way of further example, the epicyclic gear box 30 can be a star arrangement, in which the planet carrier 34 is held so as to be fixed, wherein the ring gear (or annulus) 38 is allowed to rotate. In the case of such an arrangement, the fan 23 is driven by the ring gear 38. As a further alternative example, the gear box 30 can be a differential gear box in which both the ring gear 38 and the planet carrier 34 are allowed to rotate.

It will be appreciated that the arrangement shown in FIGS. 2 and 3 is merely exemplary, and various alternatives fall within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 2) between the gear box 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gear box and the fixed structures, such as the gear box casing) may be used, and the disclosure is not limited to the exemplary arrangement of FIG. 2. For example, where the gear box 30 has a star arrangement (described above), a person skilled in the art will readily understand that the arrangement of output and support linkages and bearing positions would usually be different than that shown by way of example in FIG. 2.

Accordingly, the present disclosure extends to a gas turbine engine having an arbitrary arrangement of gear box types (for example star-shaped or planetary), support structures, input and output shaft arrangement, and bearing positions.

Optionally, the gear box may drive additional and/or alternative components (e.g. the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. By way of a further example, the gas turbine engine shown in FIG. 1 has a split flow nozzle 20, 22, meaning that the flow through the bypass duct 22 has a dedicated nozzle that is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure can be applied, for example, to any type of gas turbine engine, such as, for example, an open rotor engine (in which the fan stage is not surrounded by an engine nacelle) or a turboprop engine.

The geometry of the gas turbine engine 10, and components thereof, is or are defined using a conventional axis system which comprises an axial direction (which is aligned with the axis of rotation 9), a radial direction (in the direction from bottom to top in FIG. 1), and a circumferential direction (perpendicular to the view in FIG. 1). The axial, radial and circumferential directions run so as to be mutually perpendicular.

FIG. 4 shows a region of the gear box 30 of conventional type of construction. Here, that region of the gear box 30 which is shown in FIG. 4 comprises the planet carrier 34, which in the present case is configured with two webs 41 and 42. One of the planet gears 32 is arranged and illustrated between the webs 41 and 42 of the planet carrier 34. The planet gear 32 is mounted rotatably, by means of bearings 43, 44, in the planet carrier 34, which is likewise configured to be rotatable. In the present case, the bearings 43 and 44 are arranged in bores 45, 46 of the webs 41, 42. A torque applied to the planet carrier 34 during operation is supported in the region of the web 41, as a result of which, in the exemplary embodiment considered here, torque is output from the gear box 30 in an asymmetrical manner.

The illustration as per FIG. 4 is based substantially on a load-free operating state of the gear box 30, in the case of which an axis of rotation 47 of the planet gear 32 is oriented parallel to the axis of rotation 48 of the planet carrier.

During the operation of the gear box 30, the unilateral take-off of the torque acting on the planet carrier 34 has the effect that the planet carrier 34 is deformed or twisted in a circumferential direction. This load-specific deformation of the planet carrier 34 has the effect that the axis of rotation 47 of the planet gear 32, which in the load-free operating state of the gear box 30 runs parallel to the axis of rotation 48 of the planet carrier 34, has the course 475 illustrated in FIG. 5, which is however undesired. The course 475 of the axis of rotation 47 of the planet gear 32 impairs in each case a contact pattern of the tooth engagement between the planet gear 32 and the sun gear 28 and of the tooth engagement between the planet gear 32 and the ring gear 38, such that, during the operation of the gear box 30, the planet gears 32, the sun gear 28 and the ring gear 38 are subjected to possibly inadmissibly high load, and a service life of the planetary gear box 30 is adversely affected.

As shown in more detail in FIG. 6, a tangential deflection et, indicated in more detail in FIG. 5, of the axis of rotation 47 of the planet gear 32 relative to the axis of rotation 48 of the planet carrier increases linearly with increasing engagement force Fmesh. Here, the tangential deflection et corresponds, at a value Fmesh1 of the engagement force Fmesh, to an operating point of the gas turbine engine 10 which is typical for flight of an aircraft, which is configured with the gas turbine engine 10, in part-load operation. By contrast, at a further operating point of the gas turbine engine 30, a higher value Fmesh2 of the engagement force Fmesh acts in the region of the toothings of the planetary gear box 30. The gas turbine engine 10 is in this operating state for example during takeoff operation of an aircraft, for which reason the dwell time in this operating state is short.

FIG. 7 illustrates the course of a radial deflection erad of the axis of rotation 47 of the planet gear 32 relative to the axis of rotation 48 of the planet carrier 34 versus the rotational angular speed ω of the planet carrier 34. The course of the radial deflection erad is parabolic, because the square of the rotation angle speed ω of the planet carrier 34 is incorporated into the determination of the respectively acting centrifugal force. It can be seen from the illustration as per FIG. 7 that the radial deflection erad of the axis of rotation 47 of the planet gear 32 relative to the axis of rotation 48 of the planet carrier 34 increases with increasing rotational angular speed ω of the planet carrier 34.

FIG. 8 shows, in turn, a schematic illustration of the planet carrier 34 and of the two webs 41 and 42 and the two bores 45 and 46 of the webs 41 and 42. It can be seen from the illustration in FIG. 8 that lines of symmetry 45A and 46A of the bores 45 and 46 are arranged so as to run parallel to one another and, in the present case, have a spacing eM/C to one another, produced by manufacturing means, in a circumferential direction and in a radial direction. This has the effect that, in the load-free operating state of the gear box 30, the axis of rotation 47 in the present case encloses an angle α in the circumferential direction with the axis of rotation 48 of the planet carrier in the plane of the drawing. During the operation of the gear box 30, the course 475 of the axis of rotation 47 of the planet gear 32 is, in a predefined operating range of the gear box 30, parallel to the axis of rotation 48 of the planet carrier 34.

FIG. 9 shows a further embodiment of the gear box 30, in which the lines of symmetry 45A and 46A of the bores 45 and 46 of the webs 41 and 42 are arranged in alignment with one another and, in the load-free operating state of the gear box 30, enclose an angle β in the circumferential direction with the axis of rotation 48 of the planet carrier 34 in the plane of the drawing. Here, in the present case, the lines of symmetry 45A and 46A are also in alignment with the axis of rotation 47 of the planet gear 32 when the gear box 30 is in the load-free operating state. This in turn gives rise to a tangential deflection et of the axis of rotation 47 of the planet gear 32 in the region of the web 42, which, under load, is twisted relative to the web 41 to the extent illustrated in FIG. 5. During the operation of the gear box 30, the course 475 of the axis of rotation 47 of the planet gear 32 is, in a predefined operating range of the gear box 30, parallel to the axis of rotation 48 of the planet carrier 34.

The design embodiment of the gear box 30 illustrated in FIG. 8 and that illustrated in FIG. 9, and the respective resulting axis offsets et and erad between the axis of rotation 47 of the planet gear 32 and the axis of rotation 48 of the planet carrier 34 in the load-free operating state of the gear box 30, have the effect, depending on the operating-point-dependent configuration of the deflections et and erad, that, at the respectively applicable operating point, the axis of rotation 47 of the planet gear 32 runs parallel to the axis of rotation 48 of the planet carrier 34 to the desired extent. FIG. 10 shows the configuration as per FIG. 8 and FIG. 9, which has an effect on the tangential deflection et and on the tangential axis offset between the axes of rotation 47 and 48 of the planet gear 32 and of the planet carrier 34.

Here, it is now for example the case that, at the first value Fmesh1 of the engagement force Fmesh, the tangential deflection et is now smaller in relation to the illustration as per FIG. 6, or is equal to zero. Thus, at this operating point of the gas turbine engine 10 or of the gear box 30, obliquities, which adversely affect the service life of the gear box 30, in the tooth engagements between the planet gear 32 and the sun gear 28 and/or the ring gear 38 are reduced to a minimum, and undesired loads in this region are avoided.

The same effect can also be achieved by means of a correspondingly structurally set radial deflection erad between the axis of rotation 47 of the planet gear 32 and the axis of rotation 48 of the planet carrier 34. This is shown by a comparison of the illustrations as per FIG. 7 and FIG. 11. The course of the radial deflection erad between the axis of rotation 47 of the planet gear 32 and the axis of rotation 48 of the planet carrier 34 as shown in FIG. 11 arises during the operation of a gear box 30 designed in the manner shown in FIG. 8 or FIG. 9. Here, a radial axis offset erad between the two axes of rotation 47 and 48 at the value ω1 of the rotational angular speed ω of the planet carrier 34 as per the course shown in FIG. 11 is much smaller than in the case of the course erad as per FIG. 7 which arises during the operation of a gear box 30 as per FIG. 4, or is substantially equal to zero.

Thus, at this operating point of the gas turbine engine 10 or of the gear box 30 as per FIG. 8 or as per FIG. 9, obliquities, which adversely affect the service life of the gear box 30, in the tooth engagements between the planet gear 32 and the sun gear 28 and/or the ring gear 38 are likewise reduced to a minimum, and undesired loads in this region are avoided.

### LIST OF REFERENCE DESIGNATIONS

9 Main axis of rotation
10 Gas turbine engine
11 Core
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Thrust fan
24 Support structure
26 Shaft, connecting shaft
27 Connecting shaft
28 Sun gear
30 Gear box, planetary gear box
32 Planet gear
34 Planet carrier
36 Linkage
38 Ring gear
40 Linkage
41 Web
42 Web
43 Bearing of the planet gear
44 Bearing of the planet gear
45 Bore of the web 41
46 Bore of the web 42
45A Line of symmetry of the bore 45
46A Line of symmetry of the bore 46
47 Axis of rotation of the planet gear
48 Axis of rotation of the planet carrier
475 Further course of the axis of rotation of the planet gear
eM/C Deflection
erad Radial deflection
et Tangential deflection
Fmesh Engagement force
Fmesh1 Discrete value of the engagement force
Fmesh2 Discrete value of the engagement force
α, β Angle
ω Rotational angular speed of the planet carrier
ω1 Discrete value of the rotational angular speed

1. A gear box having at least one planet carrier which comprises two webs which are spaced apart from one another in an axial direction,
in which webs at least one planet gear which is configured to be rotatable relative to the planet carrier is operatively connected to the planet carrier, wherein the planet gear is in engagement with at least one ring gear and/or with at least one sun gear,
an axis of rotation of the planet gear, below or in the case of a defined load-dependent deformation of the planet carrier, deviates from a parallel course of an axis of symmetry of the planet carrier,
and the axis of rotation of the planet gear, in the case of a further defined load-dependent deformation of the planet carrier greater than the defined load-dependent deformation of the planet carrier, runs at least approximately parallel to the axis of symmetry of the planet carrier.

2. The gear box according to claim 1, wherein in each case one outer bearing part of a bearing of the planet gear, by means of which the planet gear is configured to be rotatable relative to the planet carrier, or in each case one end region of a planet journal on which the planet gear is rotatably mounted, are arranged rotationally fixedly in a recess of a web.

3. The gear box according to claim 2, wherein the recesses of the webs are formed as bores.

4. The gear box according to claim 3, wherein lines of symmetry of the bores run parallel to one another and so as to be offset relative to one another in a radial and/or in a tangential direction of the webs and are arranged parallel to the line of symmetry of the planet carrier or enclose an acute angle with the line of symmetry of the planet carrier.

5. The gear box according to claim 3, wherein lines of symmetry of the bores are at least approximately in alignment with one another and enclose an acute angle with the line of symmetry of the planet carrier.

6. The gear box according to claim 3, wherein, in the bores, there are arranged sleeves which are configured, in relation to an outer side of the sleeves, with in each case one asymmetrical bore, wherein lines of symmetry of the sleeves run parallel to one another and so as to be offset relative to one another in a radial and/or in a tangential direction of the webs and are arranged parallel to the line of symmetry of the planet carrier or enclose an acute angle with the line of symmetry of the planet carrier.

7. The gear box according to claim 3, wherein, in the bores, there are arranged sleeves which are configured, in relation to an outer side of the sleeves, with in each case one asymmetrical bore and whose lines of symmetry are at least approximately in alignment with one another and enclose an acute angle with the line of symmetry of the planet carrier.

8. The gear box according to claim 3, wherein lines of symmetry of outer sides of the planet journal which are operatively connected to inner sides of the bores of the webs or with inner sides of the sleeves run parallel to one another and so as to be offset relative to one another in a radial and/or in a tangential direction of the webs and are arranged parallel to the line of symmetry of the planet carrier or enclose an acute angle with the line of symmetry of the planet carrier.

9. The gear box according to claim 1, wherein the unloaded planet carrier is subjected by the installed planet gear to a twist in an axial direction, which twist is directed oppositely to a twist of the planet carrier which arises during operation.

10. The gear box according to claim 1, wherein a torque applied to the planet carrier can be supported, via one of the webs, in the region of a shaft which is connectable thereto.

11. The gear box according to claim 8, wherein a radial offset between the lines of symmetry of the bores of the webs, of the sleeves or of the outer sides of the planet journal is dependent on a radial stiffness of the planet carrier, of the planet gear and/or of the bearing of the planet gear and on a centrifugal force which acts during operation.

12. The gear box according to claim 8, wherein the tangential offset between the lines of symmetry of the bores of the webs, of the sleeves or of the outer sides of the planet journal is dependent on a tangential stiffness of the planet carrier, of the planet gear and/or of the bearing of the planet gear and on an engagement force (Fmesh) which acts in the region of the toothing of the planet gear during operation.

13. A gas turbine engine for an aircraft, said gas turbine engine comprising the following:
an engine core which comprises a turbine, a compressor and a core shaft that connects the turbine to the compressor;
a fan which is positioned upstream of the engine core, wherein the fan comprises multiple fan blades; and
a gear box, which receives an input from the core shaft and outputs drive for the fan in order to drive the fan at a lower speed than the core shaft, wherein the gear box is embodied as a gear box according to claim 1.

14. The gas turbine engine according to claim 13, wherein the turbine is a first turbine, the compressor is a first compressor, and the core shaft is a first core shaft;
the engine core furthermore comprises a second turbine, a second compressor and a second core shaft which connects the second turbine to the second compressor; and
the second turbine, the second compressor and the second core shaft are arranged so as to rotate at a higher rotational speed than the first core shaft.
